(19) United States
(12) Patent Application Publication
(10) Pub. No.: US 2009/0175277 A1
(43) Pub. Date: Jul. 9, 2009

(54) System and method for eliminating malformed packets in a multimedia-content digital transport stream

(76) Inventor: Gary E. Schultz, Lake Forest, CA (US)

Correspondence Address: HENNEMAN & ASSOCIATES, PLC, 714 W. MICHIGAN AVE., THREE RIVERS, MI, 49093, US

(21) Appl. No.: 12/008,221

(22) Filed: Jan. 9, 2008

(51) Int. Cl. H04L 12/56

(52) U.S. Cl. 370/395.1

(57) ABSTRACT

A multimedia-source system comprises a reconstruction block for counting the units of an incoming digital packet intended to comply with a digital transport stream standard, the digital transport stream standard requiring fixed-length digital packets with each digital packet containing a standard number of units, to determine at least if the unit count matches the standard number of units; and a packet transfer block coupled to the reconstruction block for transferring the digital packet to a multimedia destination if the reconstruction block determines that the unit count matches the standard number of units.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

This invention relates generally to digital media, and more particularly provides a system and method for eliminating malformed packets in a multimedia-content digital transport stream.

### BACKGROUND

Conventionally, cable and satellite content providers use various delivery methods to provide multimedia content in the form of analog signals to customers. These delivery methods typically require the cable or satellite provider to provide a set top box capable of enabling a customer to select content to be delivered to the set top box, and capable of displaying the selected content on the television set coupled to the set top box. Typically, the customer can record the selected content using a recording device, such as a video-cassette recorder (“VCR”), a digital video recorder (“DVR”), a digital versatile disk (“DVD”) recorder, or a high-definition digital video device (“HDDVD”) recorder.

At present, cable and satellite providers are moving to the delivery of multimedia content in digital formats. For example, multimedia content can be conveyed using a digital transport stream that conforms to industry standards, such as the Motion Picture Expert Group-2 (“MPEG-2™”) standard of the Motion Picture Experts Group, the DIRECTV™ standard of DIRECTV, Inc., the Digital Video Broadcasting (“DVB”) open standard, the Digital Video (“DV™”) standard of Sony Corporation, and/or the High-Definition Digital Video (“HDV™”) standard of Sony Corporation. Using a set top box, a user selects desired multimedia content. The selected multimedia content is conveyed in a digital transport stream to the set top box, which presents the multimedia content on a display device coupled to the set top box. Further, the multimedia content can be recorded by a device, e.g., a hard drive, connected to the set top box, and/or can be forwarded to other devices, e.g., a second set top box or personal computer.

Typically, multimedia content in a digital transport stream is contained in packets of fixed length. The standard packet length is typically unique to the digital transport stream standard being used, e.g., MPEG2™=188 bytes, DV™=240, 480 or 960 bytes, and HDV™ is 188 bytes. However, due to errors, digital packets received from a multimedia source may be of incorrect length, i.e., shorter or longer than the requisite packet length, for the particular digital transport stream in use. When a set top box re-assembles packets, the set top box discards those of incorrect length. Generally, because video and/or audio must be played back in real-time, the set top box typically does not request retransmission of malformed packets.

### SUMMARY

In accordance with an embodiment, the present invention provides a multimedia-source system comprising a reconstruction block for counting the units of an incoming digital packet intended to comply with a digital transport stream standard, the digital transport stream standard requiring fixed-length digital packets with each digital packet containing a standard number of units, e.g., bytes, to determine at least if the unit count matches the standard number of units; and a packet transfer block coupled to the reconstruction block for transferring the digital packet to a multimedia destination if the reconstruction block determines that the unit count matches the standard number of units.

The system may further comprise external memory for storing incoming digital packets. The reconstruction block may include a packet input control block operative to receive the incoming digital packet as a stream of units, operative to control storage of the units of the incoming digital packet in the memory, and operative to control whether to eliminate the incoming digital packet as malformed; a unit counter coupled to the packet input control block operative to count the units of the incoming digital packet as they are received; and a packet output control block coupled to the packet input control block operative to control the forwarding of the incoming digital packet to the multimedia destination if the packet input control block determines that the digital packet is not malformed. The packet input control block may include a unit counter control block operative to control the unit counter to count the units of the incoming digital packet; a packet input stream buffer and control block coupled to the unit counter and operative to control storage of the units of the incoming digital packet and to control the unit counter control block; and a good-packet output block coupled to the packet input stream buffer and control block and operative to inform the packet output control block that a properly formed digital packet is ready for transfer to the multimedia destination. The packet input control block may be operative to compare the unit count generated by the unit counter with the standard number of units each time a unit of the incoming digital packet is received. The packet input control block may be operative to search for start-packet information in each unit received and to initiate the unit counter upon detecting the start-packet information. The packet input control block may be operative to search for end-packet information in each unit received and to eliminate the digital packet if new start-packet information is received before detecting the end-packet information. The packet input control block may be operative to search for end-packet information in each unit received and to eliminate the digital packet if the end-packet information is received and the unit count generated by the unit counter is less than the standard number of units. The packet input control block may be operative to search for end-packet information in each unit received and to eliminate the digital packet if no end-packet information has been received and the unit count generated by the unit counter is greater than the standard number of units. The packet input control block may be operative to discard any additional units of the incoming digital packet until new start-packet information is received, if the end-packet information is not received and the unit count generated by the unit counter is greater than the standard number of units.

In accordance with another embodiment, the present invention provides a method by a multimedia source system comprising receiving an incoming digital packet intended to comply with a digital transport stream standard, the digital transport stream standard requiring fixed-length digital packets with each digital packet containing a standard number of units, e.g., bytes; counting the units of the incoming digital packet to determine at least if the unit count matches the standard number of units; and transferring the incoming digital packet to a multimedia destination if the reconstruction block determines that the unit count matches the standard number of units.

The step of receiving an incoming digital packet may include receiving the incoming digital packet as a stream of units; and the step of counting the units may include counting the units of the incoming digital packet as they are received. The method may further comprise controlling storage of the units of the incoming digital packet in memory as they are received; and controlling whether to eliminate the incoming digital packet as malformed from the memory. The method may further comprise comparing the unit count with the standard number of units each time a unit of the digital packet is received. The method may further comprise searching for start-packet information in each unit received; and initiating the step of counting upon detecting the start-packet information. The method may further comprise searching for end-packet information in each unit received; and eliminating the incoming digital packet if new start-packet information is received before detecting the end-packet information. The method may further comprise searching for end-packet information in each unit received; and eliminating the incoming digital packet if end-packet information is received and the unit count is less than the standard number of units. The method may further comprise searching for end-packet information in each unit received; and eliminating the incoming digital packet if no end-packet information has been received and the unit count is greater than the standard number of units. The method may further comprise discarding any additional incoming units of the incoming digital packet until new start-packet information is received, if no end-packet information has been received and the unit count is greater than the standard number of units.

In accordance with yet another embodiment, the present invention provides a multimedia source system comprising means for receiving an incoming digital packet intended to comply with a digital transport stream standard, the digital transport stream standard requiring fixed-length digital packets with each digital packet containing a standard number of units; means for counting the units of the incoming digital packet to determine at least if the unit count matches the standard number of units; and means for transferring the incoming digital packet to a multimedia destination if the reconstruction block determines that the unit count matches the standard number of units.

### BRIEF DESCRIPTION OF THE DRAWINGS

FIG. 1 is a block diagram illustrating a network system for eliminating malformed packets in a multimedia-content digital transport stream, in accordance with an embodiment of the present invention.

FIG. 2 is a block diagram illustrating details of the reconstruction block of FIG. 1, in accordance with an embodiment of the present invention.

FIG. 3 is a block diagram illustrating details of the memory of FIG. 1, in accordance with an embodiment of the present invention.

FIG. 4 is a block diagram illustrating details of the packet input control block of FIG. 2, in accordance with an embodiment of the present invention.

FIG. 5 is a flowchart illustrating a method of confirming packet size of a digital packet, in accordance with an embodiment of the present invention.

### DETAILED DESCRIPTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

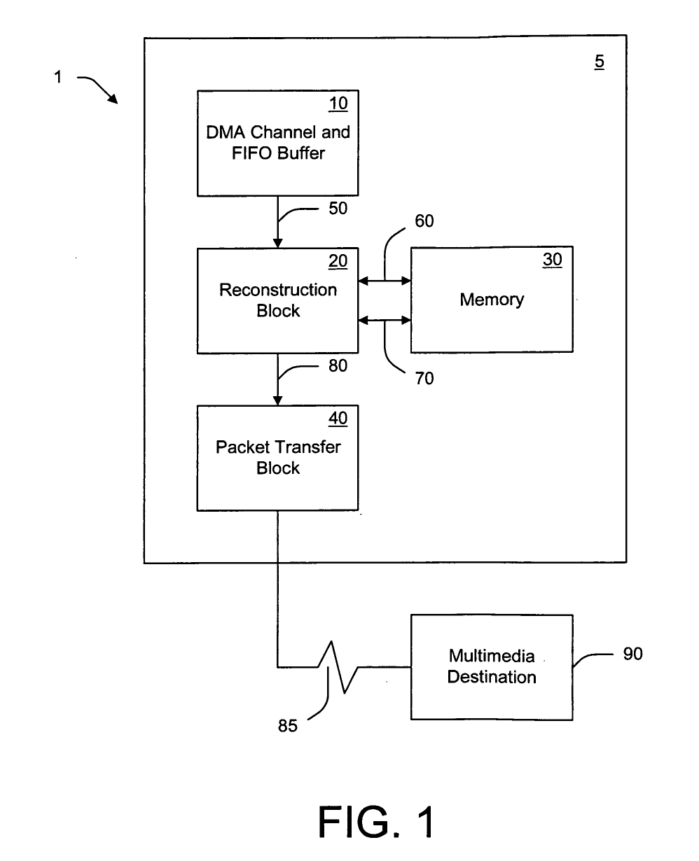

FIG. 1 is a block diagram illustrating a multimedia network system 1 that is operative to eliminate malformed packets in a multimedia-content digital transport stream, in accordance with an embodiment of the present invention. Multimedia network system 1 includes a multimedia source system 5 (e.g., one or more content servers located in a hotel, on an airplane, on the wide area network commonly referred to as the Internet, etc.; one or more intermediate servers located at an ISP, on a gateway, etc.; a desktop computer; a laptop computer; a PDA; a cellular telephone; etc.) coupled via a computer network 85 (e.g., the Internet, a local area network, a computer bus, etc.) to a multimedia destination system 90 (e.g., a laptop computer, a desktop computer, a PDA, a cellular telephone, the same machine as the multimedia source system 5, etc.).

Multimedia source system 5 is operative to examine digital packets and to eliminate malformed packets before they are sent to the multimedia destination system 90. The multimedia source system 5 comprises a direct memory access (DMA) channel and first-in-first-out (FIFO) buffer 10, coupled via a communication channel 50 to a reconstruction block 20, coupled via communication channels 60 and 70 to memory 30, e.g., external memory, and coupled via communication channel 80 to a packet transfer block 40, e.g., a multimedia switch.

The DMA channel and FIFO buffer 10 (e.g., including a 16-byte FIFO) receives multimedia content intended for transport to the multimedia-content destination system 90 from one or more content servers (not shown), and forwards the multimedia content to the reconstruction block 20. In one embodiment, the DMA channel and FIFO buffer 10 receives and forwards the multimedia content in the form of a packet stream (i.e., a stream of one or more digital packets), each packet in the packet stream being forwarded in the form of a unit stream (i.e., a stream of units), e.g., a byte stream (i.e., a stream of bytes).

The reconstruction block 20 receives the packet stream from the DMA channel and FIFO buffer 10 over the communication channel 50. As stated above, digital transport stream standards use fixed-length packets (e.g., MPEG-2™ uses a 188-byte packet length, DV™ uses a 240-byte, 480-byte or 960-byte packet length, and HDV™ uses a 188-byte packet length). Because compliant digital packets are fixed length, the reconstruction block 20 is operative to identify and eliminate malformed packets, e.g., digital packets that are either too short or too long. By eliminating malformed packets, the reconstruction block 20 prevents them from being sent to the multimedia destination system 90 and thus wasting bandwidth, processor power of the multimedia destination 90, and/or other limited resources.

More specifically, the reconstruction block 20 receives the packet stream from the DMA channel and FIFO buffer 10 via the communication channel 50. As each unit, e.g., byte, of a packet is received, the reconstruction block 20 forwards the unit via the communication channel 60 to the memory 30. The reconstruction block 20 confirms that the digital packet is not malformed. When a digital packet is received and verified, the reconstruction block 20 is operative to obtain the digital packet from the memory 30 via the communication channel 70 and to send the digital packet via the communication channel 80 to the packet transfer block 40. However, if malformed, the reconstruction block 20 eliminates the digital packet from the memory 30, preventing it from being transferred to the packet transfer block 40. Thus, in one embodiment, the computer network 85 is not burdened with sending and the multimedia destination system 90 is not burdened with processing malformed packets.

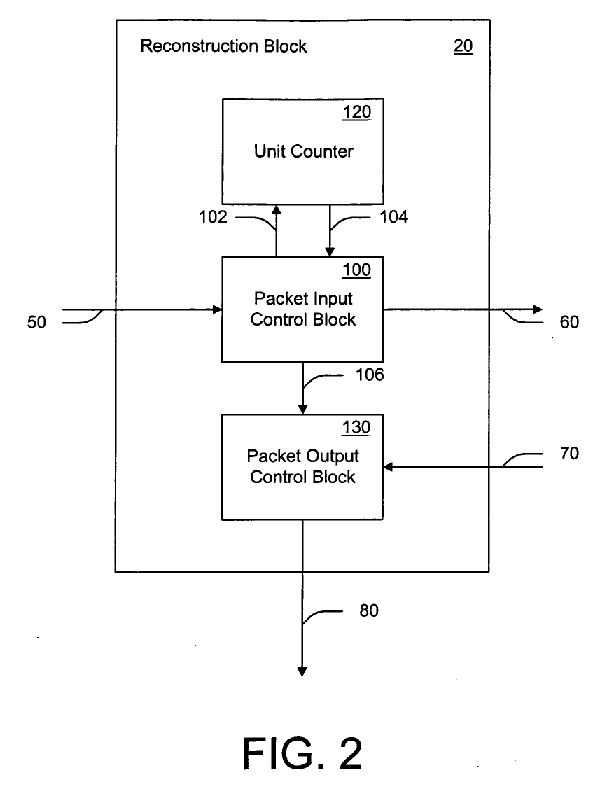

FIG. 2 illustrates details of the reconstruction block 20, in accordance with an embodiment of the present invention. The reconstruction block 20 includes a packet input control block 100, a unit (e.g., bit, byte, word, etc.) counter block 120, and a packet output control block 130.

The packet input control block 100 receives the units of an incoming digital packet of a packet stream from the DMA channel and FIFO buffer 10 via the communication channel 50. The packet input control block 100 looks for start-packet information embedded within each unit of the incoming digital packet of the packet stream. Upon detection of start-packet information, the packet input control block 100 sends an initiate_unit_count control signal over the communication channel 102 to the unit counter 120 to initiate a unit count. As additional units are received, the packet input control block sends an increment_unit_count control signal to the unit counter 120 to increment the unit count. The packet input control block 100 sends each unit of each digital packet over the communication channel 60 to the memory 30 (see FIG. 1) for storage.

Further, as each unit is received, the packet input control block 100 obtains the unit count from the byte counter 120 via communication channel 104 and compares the unit count, i.e., the current packet length, against the predetermined standard packet length. If the current packet length exceeds or clearly will exceed the predetermined standard packet length, then the packet input control block 100 eliminates the received digital packet, preventing it from being forwarded to the packet transfer block 40 and thus to the output multimedia destination system 90. In some embodiments, the packet input control block 100 may determine whether the current packet length is equal to the predetermined standard packet length. In other embodiments, the unit counter may decrement its count from a predetermined number, e.g., the standard packet length.

Further, the packet input control block 100 looks for end-packet information in each unit of the incoming digital packet in the packet stream. When the packet input control block 100 detects end-packet information, the packet input block 100 obtains the unit count from the unit counter 120 via communication channel 104 and compares the unit count, i.e., the actual packet length, against the predetermined standard packet length. If the actual packet length matches the predetermined standard packet length, then the packet input control block 100 sends a good-packet control signal over communication channel 106 to the packet output control block 130. In response to the good-packet control signal, the packet output control block 130 obtains the digital packet from memory 30 over communication channel 70, and forwards the digital packet to the packet transfer block 40 (see FIG. 1) over communication channel 80. If, however, the actual packet length does not match the predetermined standard packet length, then the packet input control block 100 eliminates the received digital packet from memory 30, preventing it from being forwarded to the packet transfer block 40 and thus to the output multimedia destination system 90.

In another embodiment, the packet input control block 100 may not send a good-packet control signal, and alternatively may just eliminate it from memory 30.

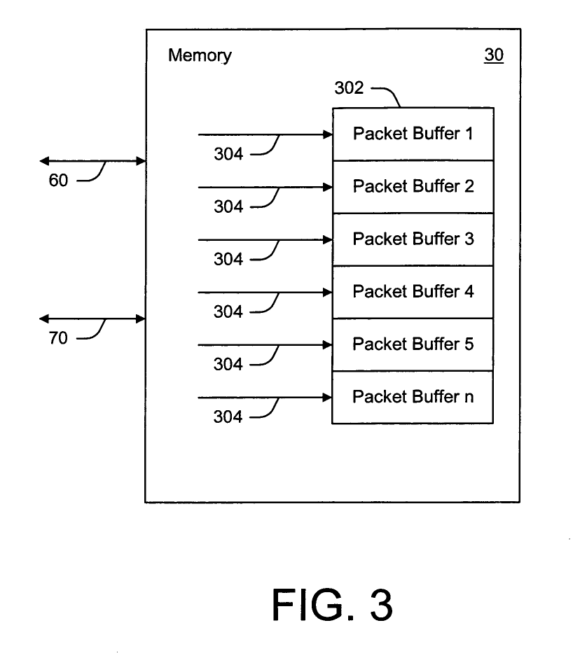

FIG. 3 is a block diagram illustrating details of the memory 30, in accordance with an embodiment of the present invention. The memory 30 includes multiple packet buffers 302 (shown as packet buffers 1-n) and associated buffer pointers 304. The received units of the incoming digital packets are stored in the packet buffers 302 as they are received over communication channel 60 from the packet input control block 100. Further, the digital packets are retrieved from the packet buffers 302 by the packet output control block 130 (FIG. 2) over communication channel 70. The packet input control block 100, in coordination with the memory 30, is operative to control each packet buffer pointer 304 to point to the address of a packet buffer 302 where the next received unit of anew digital packet should be stored. The packet input control block 100, in coordination with the memory 30, is further operative to reset each packet buffer pointer 304 to point to the start address of a packet buffer 302 as a digital packet is forwarded to the packet transfer block 40 or as a malformed packet is eliminated therefrom.

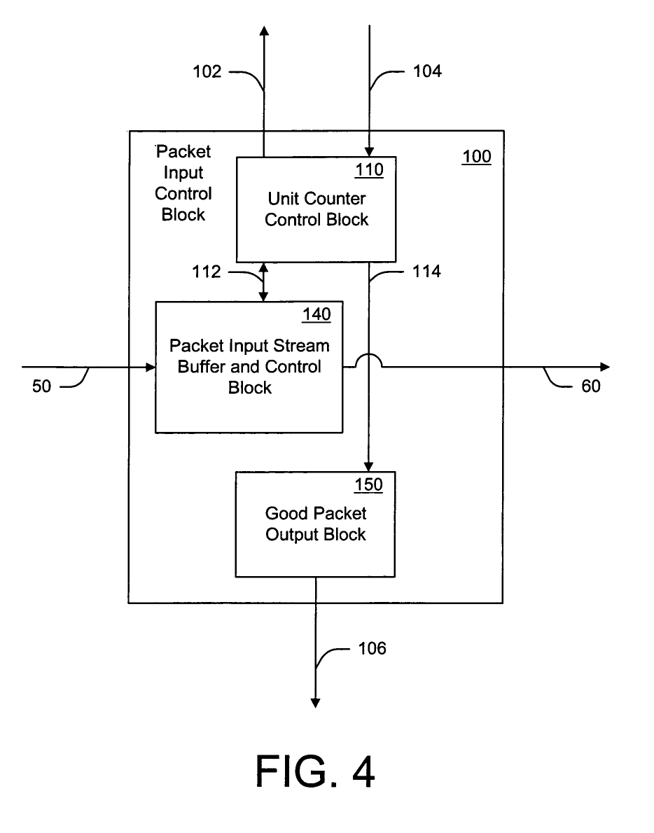

FIG. 4 is a block diagram illustrating details of the packet input control block 100, in accordance with an embodiment of the present invention. The packet input control block 100 includes a unit counter control block 110, a packet input stream buffer and control block 140, and a good-packet output block 150.

The packet input stream buffer and control block 140 receives the units of the incoming digital packet of the packet stream over communication channel 50 and searches for start-packet information contained within the packet header of each unit. Upon detection of start-packet information, the packet input stream buffer and control block 140 signals the unit counter control block 110 over communication channel 112 to reset the current count of the unit counter 120 (FIG. 2). Further, the packet input stream buffer and control block 140 sends the unit data and a start-packet control signal over communication channel 60 to the memory 30. In response to the unit data and start-packet control signal, the memory 30 stores the unit data into a new packet buffer 302 and creates a packet buffer pointer 304.

As each subsequent unit of the digital packet is received, the packet input stream buffer and control block 140 signals the unit counter control block 110 and sends the unit data to the memory 30. In response, the memory 30 adds the unit data to the current packet buffer 302. Also in response, the unit counter control block 110 sends a control signal over communication channel 102 to the unit counter 120 to increment its unit count.

The unit counter 120 (FIG. 2) increments its unit count and returns the current unit count over communication channel 104 to the unit counter control block 110. The unit counter control block 110 compares the current unit count with the known standard unit count of a properly formed digital packet.

If the current unit count is greater than the standard unit count, then the unit counter control block 110 signals the packet input stream buffer and control block 140 to discontinue sending units for this digital packet to the memory 30 (FIG. 1). The packet pointer 304 to the packet buffer 302 in memory 30 is reset, thereby eliminating the malformed packet from the packet buffer 302. The packet input stream buffer and control block 140 searches for end-of-packet information from the packet stream. If the packet input stream buffer and control block 140 receives start-packet information, never receiving end-of-packet information, then the packet input stream buffer and control block 140 initiates handling the new packet.

If the current unit count is still less than the standard unit count, then the packet input stream buffer and control block 140, unit counter control block 110, unit counter 120 (FIG. 2), and memory 30 (FIG. 1) continue until the packet input stream buffer and control block 140 receives end-of-packet information or start-packet information embedded within the digital packet stream.

When end-of-packet information is received and the unit counter control block 110 has not signaled a packet overrun, the packet input stream buffer and control block 140 sends an end_of_packet control signal over communication channel 112 to the unit counter control block 110. The unit counter control block 110 instructs the unit counter 120 to increment its unit count and receives the current unit count back from the unit counter 120. The unit counter control block 110 compares the current unit count with the standard unit count. If the current unit count is less than the standard unit count, then the pointer 304 to the packet buffer 302 in the memory 30 (FIG. 1) is reset, thereby eliminating the malformed packet from the packet buffer 302 (FIG. 3) of the memory 30. If the current unit count matches the standard unit count, then the unit counter control block 110 uses communication channel 114 to send a good-packet control signal to the good-packet output block 150, which uses communication channel 106 to notify the packet output control block 130 that a properly formed packet has been received and is ready for transfer. The packet output control block 130 obtains the digital packet from the packet buffer 302 of the memory 30 over communication channel 70, and streams the digital packet over communication channel 80 to the packet transfer block 40 (FIG. 1).

When start-packet information is received before receiving anticipated end-packet information and the unit counter control block 110 has not signaled a packet overrun, the packet input stream buffer and control block 140 recognizes that the received packet is malformed. The packet input stream buffer and control block 140 instructs the memory 30 to reset the pointer 304 to the packet buffer 302, thereby eliminating the malformed packet from the packet buffer 302 (FIG. 3) of the memory 30. Further, the packet inputs stream buffer and control block 140 instructs the unit counter control block 110 to reset the unit counter 120, and to begin the unit count of a new digital packet.

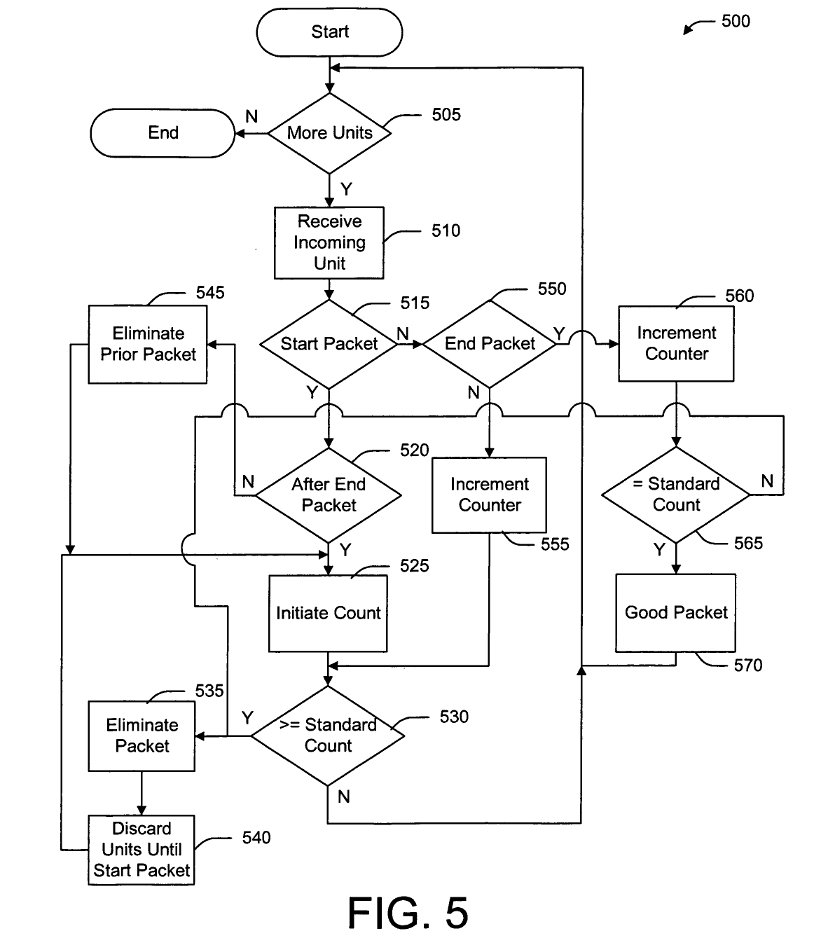

FIG. 5 is a flowchart illustrating a method 500 of eliminating a malformed packet, in accordance with an embodiment of the present invention. Method 500 begins with the packet input control block 100 in step 505 determining whether there is an incoming unit stream. If not, then method 500 ends. If so, then the packet input control block 100 in step 510 receives the next incoming unit. The packet input control block 100 in step 515 determines if the incoming unit includes start-packet information of a new digital packet. If so, then the packet input control block 100 in step 520 determines if the start-packet information arrives immediately after end-packet information of a prior digital packet. If not, then the packet input control block 100 in step 545 eliminates the prior packet as malformed, since the prior packet never included end-packet information, and then proceeds to step 525. If the start-packet information does arrive immediately after end-packet information of a prior digital packet, then the method 500 proceeds to step 525.

In step 525, the packet input control block 100 initiates the unit counter 120 to begin counting units (e.g., resets the counter and increments the start-count by one). The packet input control block 100 in step 530 determines if the current count generated by the unit counter 120 (before having received the end-packet information) is greater than or equal to the standard number of units per the digital transport stream standard. If so, then the packet input control block 100 in step 535 eliminates the digital packet, in step 540 discards any remaining units until the next start packet information is received, and returns to step 525 to initiate the unit counter 120 again. If the current count generated by the unit counter 120 is still less than the standard number of units, then the method 500 returns to step 505 to receive the next incoming unit.

If the packet input control block 100 in step 515 determines that the incoming packet does not include start-packet information, then the packet input control block 100 in step 550 determines if the incoming packet includes end-packet information. If not, i.e., the incoming packet is a body packet, then the packet input control block 100 in step 555 increments the unit counter 120 and proceeds to step 530 to re-test the current count against the standard number of units.

If the packet input control block 100 in step 550 determines that the incoming packet includes end-packet information, then the packet input control block 100 in step 560 increments the unit counter 120, and in step 565 determines if the current count generated by the unit counter 120 equals the standard number of units per the digital transport stream standard. If not, then the packet input control block 100 jumps to step 535 to eliminate the packet as malformed. If so, then the packet input control block 100 in step 570 determines that the current packet is a good packet, and thus does not eliminate the packet. Method 500 then returns to step 505 to receive the next packet.

Although method 500 is discussed in an embodiment that includes an incrementing unit counter 120, other embodiments that use a decrementing unit counter 120 are also possible.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general-purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A multimedia-source system comprising:
a reconstruction block for counting the units of an incoming digital packet intended to comply with a digital transport stream standard, the digital transport stream standard requiring fixed-length digital packets with each digital packet containing a standard number of units, to determine at least if the unit count matches the standard number of units; and
a packet transfer block coupled to the reconstruction block for transferring the digital packet to a multimedia destination if the reconstruction block determines that the unit count matches the standard number of units.

2. The system of claim 1, further comprising external memory for storing incoming digital packets.

3. The system of claim 2, wherein the reconstruction block includes
a packet input control block operative to receive the incoming digital packet as a stream of units, operative to control storage of the units of the incoming digital packet in the memory, and operative to control whether to eliminate the incoming digital packet as malformed;
a unit counter coupled to the packet input control block operative to count the units of the incoming digital packet as they are received; and
a packet output control block coupled to the packet input control block operative to control the forwarding of the incoming digital packet to the multimedia destination if the packet input control block determines that the digital packet is not malformed.

4. The system of claim 3, wherein the packet input control block includes
a unit counter control block operative to control the unit counter to count the units of the incoming digital packet;
a packet input stream buffer and control block coupled to the unit counter and operative to control storage of the units of the incoming digital packet and to control the unit counter control block; and
a good-packet output block coupled to the packet input stream buffer and control block and operative to inform the packet output control block that a properly formed digital packet is ready for transfer to the multimedia destination.

5. The system of claim 3, wherein the unit is a byte.

6. The system of claim 3, wherein the packet input control block is operative to compare the unit count generated by the unit counter with the standard number of units each time a unit of the incoming digital packet is received.

7. The system of claim 6, wherein the packet input control block is operative to search for start-packet information in each unit received and to initiate the unit counter upon detecting the start-packet information.

8. The system of claim 6, wherein the packet input control block is operative to search for end-packet information in each unit received and to eliminate the digital packet if new start-packet information is received before detecting the end-packet information.

9. The system of claim 6, wherein the packet input control block is operative to search for end-packet information in each unit received and to eliminate the digital packet if the end-packet information is received and the unit count generated by the unit counter is less than the standard number of units.

10. The system of claim 6, wherein the packet input control block is operative to search for end-packet information in each unit received and to eliminate the digital packet if no end-packet information has been received and the unit count generated by the unit counter is greater than the standard number of units.

11. The system of claim 10, wherein, if the end-packet information is not received and the unit count generated by the unit counter is greater than the standard number of units, then the packet input control block is operative to discard any additional units of the incoming digital packet until new start-packet information is received.

12. A method by a multimedia source system comprising:
receiving an incoming digital packet intended to comply with a digital transport stream standard, the digital transport stream standard requiring fixed-length digital packets with each digital packet containing a standard number of units;
counting the units of the incoming digital packet to determine at least if the unit count matches the standard number of units; and
transferring the incoming digital packet to a multimedia destination if the reconstruction block determines that the unit count matches the standard number of units.

13. The method of claim 12, wherein
the step of receiving an incoming digital packet includes receiving the incoming digital packet as a stream of units; and
the step of counting the units includes counting the units of the incoming digital packet as they are received.

14. The method of claim 13, further comprising
controlling storage of the units of the incoming digital packet in memory as they are received; and
controlling whether to eliminate the incoming digital packet as malformed from the memory.

15. The method of claim 13, wherein the unit is a byte.

16. The method of claim 13, further comprising comparing the unit count with the standard number of units each time a unit of the digital packet is received.

17. The method of claim 16, further comprising
searching for start-packet information in each unit received; and
initiating the step of counting upon detecting the start-packet information.

18. The method of claim 16, further comprising
searching for end-packet information in each unit received; and
eliminating the incoming digital packet if new start-packet information is received before detecting the end-packet information.

19. The method of claim 16, further comprising
searching for end-packet information in each unit received; and
eliminating the incoming digital packet if end-packet information is received and the unit count is less than the standard number of units.

20. The method of claim 16, further comprising
searching for end-packet information in each unit received; and
eliminating the incoming digital packet if no end-packet information has been received and the unit count is greater than the standard number of units.

21. The method of claim 20, further comprising
if no end-packet information has been received and the unit count is greater than the standard number of units, then discarding any additional incoming units of the incoming digital packet until new start-packet information is received.

22. A multimedia source system comprising:
means for receiving an incoming digital packet intended to comply with a digital transport stream standard, the digital transport stream standard requiring fixed-length digital packets with each digital packet containing a standard number of units;
means for counting the units of the incoming digital packet to determine at least if the unit count matches the standard number of units; and
means for transferring the incoming digital packet to a multimedia destination if the reconstruction block determines that the unit count matches the standard number of units.
